(19) United States
(12) Patent Application Publication
(10) Pub. No.: US 2025/0293476 A1
(43) Pub. Date: Sep. 18, 2025

(54) WIRE INSERTION TOOLS AND METHODS

(71) Applicant: The Boeing Company, Arlington, VA (US)

(72) Inventors: Thomas E. Dowhower, Goose Creek, SC (US); Heath W. Haga, Mount Pleasant, SC (US); Peter M. Heinrich, Mount Pleasant, SC (US)

(73) Assignee: The Boeing Company, Arlington, VA (US)

(21) Appl. No.: 18/606,250

(22) Filed: Mar. 15, 2024

(51) Int. Cl. H01R 43/28

(52) U.S. Cl. CPC H01R 43/28

(57) ABSTRACT

A tool for inserting and pull-testing a wire includes a frame. The frame includes a handle and a working end. The tool includes a receiver. The received is disposed at the working end. The receiver is configured to hold an insertion tip. A wire passes through the insertion tip. The tool includes a gripper. The gripper is coupled to the frame. The gripper is selectively movable between an engaged position and a disengaged position. In the engaged position, the gripper clamps the wire to prevent movement of the frame relative to the wire. In the disengaged position, the gripper unclamps the wire to enable movement of the frame relative to the wire.

### FIELD

The present disclosure relates generally to electrical connections and, more particularly, to tools and methods for installing a wire in an electrical contact and pull-testing the connection.

### BACKGROUND

A push-in wire connector is a commonly utilized type of wire connection. The push-in connector generally includes an electrically insulated housing, at least one conductive wire retainer disposed in the housing, and at least one opening that provides access to the wire retainer. An end of an electrical wire can be inserted through the opening to engage the wire retainer. The wire retainer often includes a spring clip that receives and holds the end of the electrical wire to prevent the wire from being unintentionally pulled out of the housing. Insertion of the wire is typically performed manually. Additionally, in certain industries, such as the aircraft industry, a manual pull test is performed on each wire after installation. In many cases, this installation and testing action is performed a large number of times, which can result in hand fatigue and/or improperly connected or tested wires. Accordingly, those skilled in the art continue with research and development efforts in electrical wire installation and testing.

### SUMMARY

Disclosed are examples of a tool for inserting and removing a wire and a method for inserting and removing a wire. The following is a non-exhaustive list of examples, which may or may not be claimed, of the subject matter according to the present disclosure.

In an example, the disclosed tool includes a frame. The frame includes a handle and a working end. The tool includes a receiver. The received is disposed at the working end. The receiver is configured to hold an insertion tip. A wire passes through the insertion tip. The tool includes a gripper. The gripper is coupled to the frame. The gripper is selectively movable between an engaged position and a disengaged position. In the engaged position, the gripper clamps the wire to prevent movement of the frame relative to the wire. In the disengaged position, the gripper unclamps the wire to enable movement of the frame relative to the wire.

In another example, the disclosed tool includes a frame. The frame includes a handle and a working end. The tool includes an insertion tip disposed at the working end. The insertion tip is configured to enable a wire to pass through the insertion tip. The tool includes a gripper. The gripper is coupled to the frame. The gripper is selectively movable between an engaged position and a disengaged position. In the engaged position, the gripper clamps the wire to prevent movement of the frame relative to the wire. In the disengaged position, the gripper unclamps the wire to enable movement of the frame relative to the wire.

In an example, the disclosed method includes steps of: (1) installing a wire in a tool; (2) inserting a wire end of the wire into a contact opening of a contact block using the tool; (3) clamping the wire with a gripper of the tool; and (4) with the gripper clamped to the wire, applying a pull force to the wire using the tool.

Other examples of the tool and the method will become apparent from the following detailed description, the accompanying drawings, and the appended claims.

### BRIEF DESCRIPTION OF THE DRAWINGS

FIG. 1 is a schematic block diagram of an example of a tool for inserting and testing a wire;

FIG. 2 is a flow diagram of an example of a method for inserting and testing a wire;

FIG. 3 is a schematic, perspective view of an example of the tool;

FIG. 4 is a schematic, perspective view of an example of the tool;

FIG. 5 is a schematic, perspective view of an example of the tool;

FIG. 6 is a schematic, perspective view of an example of the tool;

FIG. 7 is a schematic, section view of an example of the tool;

FIG. 8 is a schematic, perspective view of an example of the tool;

FIG. 9 is a schematic, section view of an example of the tool;

FIG. 10 is a flow diagram of an example of an aircraft manufacturing and service method; and

FIG. 11 is a schematic illustration of an example of an aircraft.

### DETAILED DESCRIPTION

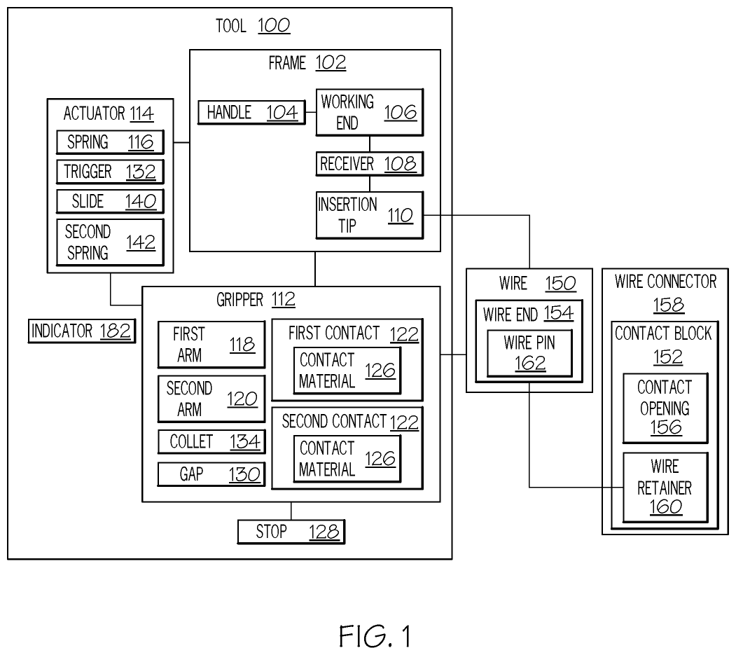

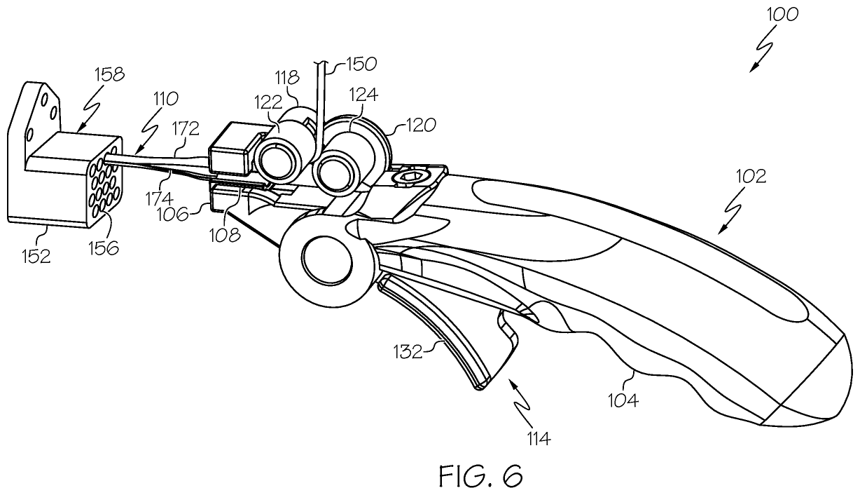

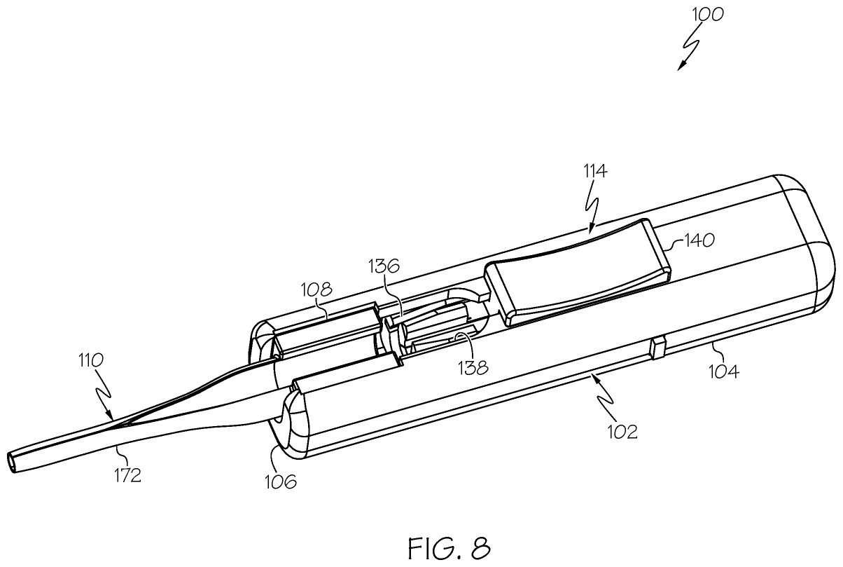

Referring generally to FIGS. 1-9, by way of examples, the present disclosure is directed to a tool 100 and a method 1000 for installing an electrical wire 150 into a wire connector 158. Examples of the tool 100 and method 1000 are used to install (e.g., insert) wire ends or wire pins of the wire 150 into ground blocks, terminal blocks, and/or other push-in style wire connectors. The tool 100 and method 1000 also provide a pull-check feature.

In various examples, the tool 100 includes or utilizes an insertion tip that is incorporated into a handle. The pull-check feature allows for immediate validation that the wire pin is properly seated and retained in the wire connector. The pull-check feature also provides a consistent and repetitive pull force. The test can be performed immediately after the wire pin has been inserted in the connector block. The tool 100 and the method 1000 help alleviate pain or discomfort that a user may experience due to repeated installation and testing of wire connections, as the conventional alternative is to tightly grip the wire with the fingers. The tool 100 and the method 1000 also helps the user reinforce a habit of performing an immediate pull check on the installed wire before moving to the next wire.

Referring to FIG. 1, the wire connector 158 generally includes any one of various types and/or styles of push-in wire connectors or terminal blocks that enable physical and electrical connections simply by inserting a wire end 154 (e.g., bare wire) of the electrical wire 150. The wire connector 158 includes a contact block 152 that includes or forms an electrically insulated housing. The wire connector 158 includes at least one wire retainer 160 that is electrically conductive and that is disposed in the housing of the contact block 152. The wire connector 158 also includes at least one contact opening 156 formed in the contact block 152 and that provides access to the wire retainer 160. The wire retainer 160 includes a spring clip or other clamping mechanism that receives and holds the wire end 154 of the wire 150 to prevent the wire 150 from being unintentionally pulled out of the wire connector 158. The wire end 154 of the wire 150 is inserted through the contact opening 156 to engage, make electrical contact with, and be retained by the wire retainer 160. In some examples, the wire 150 includes a wire pin 162 that is coupled to or otherwise disposed at the wire end 154. The wire pin 162 is configured for insertion into, electrical connection with, and retention by the wire retainer 160.

Referring now to FIGS. 1 and 3-9, the following are examples of the tool 100, according to the present disclosure. The tool 100 includes a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

Referring to FIG. 1, as will be described in more detail herein, in various examples, the tool 100 includes a number of components, including one or more of a frame 102, a handle 104, a working end 106, a receiver 108, an insertion tip 110, a gripper 112, an actuator 114, a spring 116, a first arm 118, a second arm 120, a first contact 122, a second contact 124, a stop 128, a trigger 132, a collet 134, a slide 140, and a second spring 142.

Referring to FIGS. 1 and 3-9, in one or more examples, the tool 100 includes the frame 102, the receiver 108, and the gripper 112. The frame 102 includes the handle 104 and the working end 106. The receiver 108 is disposed at the working end 106. The receiver 108 is configured to hold the insertion tip 110. The insertion tip 110 is configured such that the wire 150 passes through the insertion tip 110. The gripper 112 is coupled to the frame 102. The gripper 112 is selectively movable between an engaged position and a disengaged position. In the engaged position, the gripper 112 clamps the wire 150 to prevent movement of the frame 102 relative to the wire 150. In the disengaged position, the gripper 112 unclamps (e.g., releases) the wire 150 to enable movement of the frame 102 relative to the wire 150.

The insertion tip 110 enables insertion of the wire end 154 of the wire 150 through the contact opening 156 and into engagement with the wire retainer 160. In one or more examples, the insertion tip 110 includes any one of various styles or configurations typical to wire insertion tips of the kind used to install wires into push-in style electrical connectors.

In one or more examples, the insertion tip 110 includes a tubular body 172 having an open interior and open ends through with the wire 150 can pass. In one or more examples, the insertion tip 110 is a cylindrical split insertion tip having a slot 174 extending longitudinally along a wall of the tubular body 172.

In one or more examples, an insertion end of the insertion tip 110 is configured (e.g., sized and shaped) to be inserted in the contact opening 156 of the wire connector 158. In one or more examples, the insertion end of the insertion tip 110 is also configured to engage a flange or enlarged diameter of the wire pin 162 disposed at the wire end 154 of the wire 150 such that the insertion tip 110 can push the wire pin 162 into engagement with the wire retainer 160.

In one or more examples, a connection end of the insertion tip 110, opposite the insertion end, is configured to be coupled to the end 106 of the frame 102 of the tool 100. For example, the receiver 108 is configured to receive the connection end of the insertion tip 110.

In one or more examples, the insertion tip 110 is a commercially available component, such as a solid barrel contact insert extract tool in wiring interconnect systems available from JRD Tools.

The receiver 108 enables connection, interchange, and/or replacement of the insertion tip 110. In one or more examples, the receiver 108 of the tool 100 includes or takes the form of a recess, a slot, or other type of opening disposed at the working end 106 of the frame 102 that is configured to receive and securely retain the connection end of the insertion tip 110.

In one or more other examples, the tool 100 includes the insertion tip 110. In these examples, the insertion tip 110 can be integrated into the frame 102 of the tool 100 at the working end 106. Other configurations and/or styles of the insertion tip 110, the receiver 108, and/or the working end 106 of the tool 100 are also contemplated.

The handle 104 provides a suitable structure for a use to hold during use of the tool 100 for installing the wire 150 and testing the mechanical connection of the wire 150 with the wire connector 158. The handle 104 can take any one of various forms. In one or more examples, the handle 104 has various ergonomic features that enable comfortable gripping by the user, such as finger reliefs, padding, surface textures, and the like.

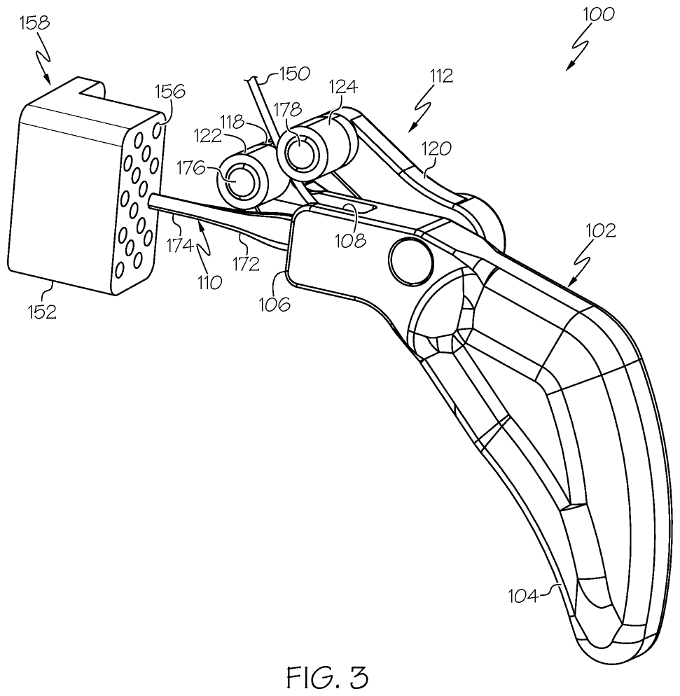

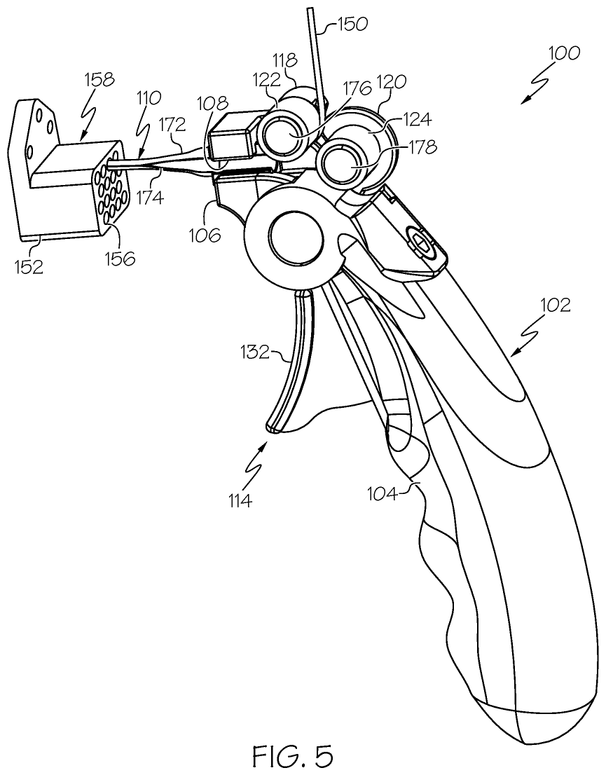

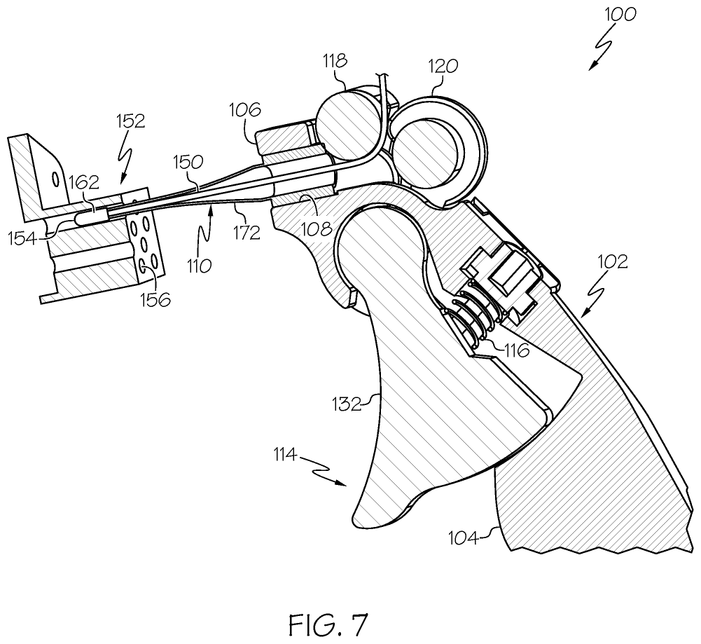

In one or more examples, the handle 104 is approximately in-line with the working end 106 and, thus, the insertion tip 110 (e.g., as shown by examples in FIGS. 3, 4, 6, 8 and 9). In one or more examples, the handle 104 is oriented at an angle (e.g., approximately perpendicular) relative to the working end 106 and, thus, the insertion tip 110 (e.g., as shown by examples in FIGS. 5 and 7). The form factor of the tool 100 and, more particularly, of relative orientations of the handle 104 and the working end 106 of the frame 102 may depend on various factors, such as the type of actuation mechanism used to engage and disengage the gripper 112, the style of the wire connector 158, the work location, access space, and the like.

Referring to FIGS. 1 and 3-9, in one or more examples, the tool 100 includes the actuator 114. The actuator 114 is configured to move the gripper 112 between the engaged position and the disengaged position. In one or more examples, the actuator 114 is manually engaged by the user of the tool 100.

In one or more examples, change of the position, state, or configuration of the gripper 112 between the engaged position and the disengaged position occurs automatically, passively, or without active engagement by the user. In one or more examples, change of the position, state, or configuration of the gripper 112 between the engaged position and the disengaged position requires active engagement by the user.

In one or more examples, the actuation mechanism is coupled to the gripper 112 such that the actuation action changes the position, state, or configuration of the gripper 112 from the disengaged position to the engaged position. In these examples, the tool 100 (e.g., the gripper 112) is naturally in the disengaged position for installation of the wire 150 in the tool 100 (e.g., in the gripper 112). With the wire 150 installed in the tool 100, the user actively transitions the tool 100 (e.g., the gripper 112) from the disengaged position to the engaged position to grasp the wire 150 for insertion in and connection to the wire connector 158 and/or for pull-testing of the wire 150.

In one or more examples, the actuation mechanism is coupled to the gripper 112 such that the actuation action changes the position, state, or configuration of the gripper 112 from the engaged position back to the disengaged position. In these examples, the tool 100 (e.g., the gripper 112) is naturally in the engaged position. The user actively transitions the tool 100 (e.g., the gripper 112) from the engaged position to the disengaged position for installation of the wire 150 in the tool 100 (e.g., in the gripper 112). With the wire 150 installed in the tool 100, the tool 100 (e.g., the gripper 112) passively transitions from the disengaged position back to the engaged position to grasp the wire 150 for insertion in and connection to the wire connector 158 and/or for pull-testing of the wire 150.

In one or more examples, the actuator 114 includes or takes the form of any suitable mechanical device or mechanism capable of converting a force applied by the user into motion of the gripper 112 (e.g., between the engaged and disengaged positions). In one or more examples, the actuator 114 includes or takes the form of any suitable electrical or electromechanical device or mechanism capable of converting an input applied by the user into motion of the gripper 112 (e.g., between the engaged and disengaged positions).

Referring to FIGS. 1 and 3-9, in one or more examples, the tool 100 includes the spring 116. In one or more examples, the spring 116 is configured to bias the gripper 112 in the disengaged position. In these examples, engagement or actuation of the actuator 114 overcomes the bias of the spring 116 to move the gripper 112 from the disengaged position to the engaged position. In one or more examples, the spring 116 is configured to bias the gripper 112 in the engaged position. In these examples, engagement or actuation of the actuator 114 overcomes the bias of the spring 116 to move the gripper 112 from the engaged position to the disengaged position.

In one or more examples, the spring 116 is integrated into, included with, or forms a part of the actuator 114. In one or more examples, the spring 116 is a separate or independent mechanism or element of the tool 100.

Referring to FIGS. 1 and 3-7, in one or more examples of the tool 100, the gripper 112 includes the first arm 118 and the second arm 120. In one or more examples, the first arm 118 is fixed relative to the frame 102. The second arm 120 is movable relative to the frame 102 and relative to the first arm 118. In these examples, the movement of the second arm 120 relative to the first arm 118 moves the gripper 112 between the disengaged position and the engaged position. In one or more examples, the first arm 118 is also movable relative to the frame 102 and the second arm 120. In these examples, the movement of the first arm 118 and the second arm 120 relative to each other moves the gripper 112 between the disengaged position and the engaged position. In either of these examples, the wire 150 is gripped or otherwise held between the first arm 118 and the second arm 120 when the gripper 112 is in the engaged position.

In various examples of the tool 100, the first arm 118 and the second arm 120 have any suitable structural configuration and/or arrangement. In one or more examples, the first arm 118 is coupled to the frame 102 and/or extends from the frame 102. In one or more examples, the second arm 120 is coupled to the frame 102 and/or extends from the frame 102. The first arm 118 and the second arm 120 are arranged or situated relative to each other and the frame 102 such that a gap 130 is formed by the gripper 112 (e.g., between the first arm 118 and the second arm 120) within or through which the wire 150 can pass. In one or more examples, the first arm 118 and/or the second arm 120 are coupled to the frame 102 in any suitable manner as to enable movement of the gripper 112 between the engaged position and the disengaged position to grip and hold the wire 150 therebetween.

Referring to FIGS. 1 and 3-7, in one or more examples of the tool 100, the second arm 120 is rotationally movable relative to the frame 102. In these examples, rotation of the second arm 120 about an axis, for example, that passes through the frame 102, moves the second arm 120 toward and/or away from the first arm 118 and, thus, transitions the gripper 112 between the engaged position and the disengaged position.

In one or more examples, rotation of the second arm 120, for example, toward the first arm 118 (e.g., into the engaged position) and/or away from the first arm 118 (e.g., into the disengaged position), is actively initiated manually, such as by engaging the actuator 114 (e.g., as shown by examples illustrated in FIGS. 5-7).

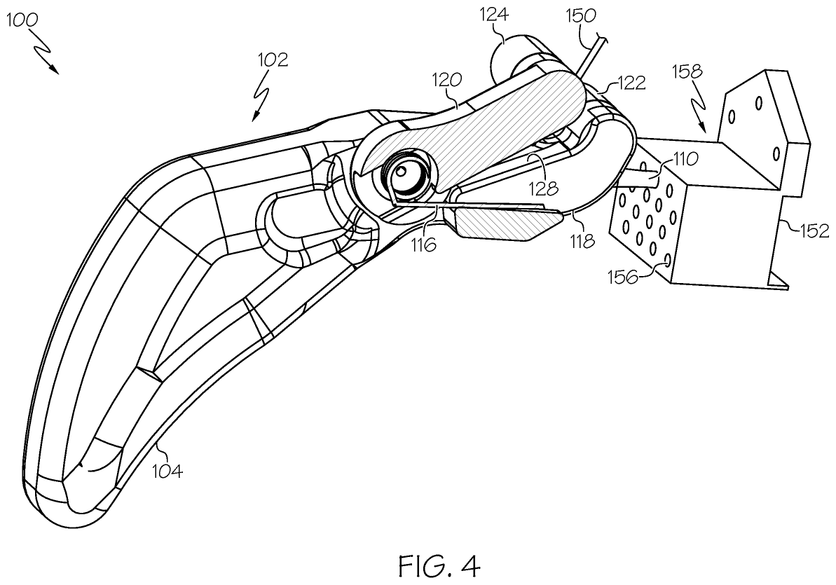

In one or more examples, rotation of the second arm 120, for example, toward the first arm 118 (e.g., into the engaged position) and/or away from the first arm 118 (e.g., into the disengaged position), is actively initiated manually, such as by directly engaging the second arm 120 (e.g., as shown by examples illustrated in FIGS. 3 and 4).

In one or more examples, rotation of the second arm 120, for example, toward the first arm 118 (e.g., return to the engaged position) and/or away from the first arm 118 (e.g., return to the disengaged position), is passively initiated, such as by the spring 116 that biases the gripper 112 in either the engaged position (e.g., the second arm 120 rotated toward the first arm 118) or the disengaged position (e.g., the second arm 120 rotated away from the first arm 118).

In one or more examples, the first arm 118 is also rotationally movable relative to the frame 102 and the second arm 120. In these examples, rotation of the first arm 118 and/or the second arm 120 moves the first arm 118 and the second arm 120 toward and/or away each other and, thus, transitions the gripper 112 between the engaged position and the disengaged position.

In one or more examples, the second arm 120 and/or the first arm 118 is coupled to the frame 102 via a suitable rotary joint, such as a pin, a hinge, a bearing, a rotary fastener, or the like.

Referring to FIGS. 1, in one or more examples of the tool 100, the second arm 120 is linearly movable relative to the frame 102. In these examples, linear motion (e.g., translation) of the second arm 120 along an axis, for example, that passes through the frame 102, moves the second arm 120 toward and/or away from the first arm 118 and, thus, transitions the gripper 112 between the engaged position and the disengaged position.

In one or more examples, linear movement of the second arm 120, for example, toward the first arm 118 (e.g., into the engaged position) and/or away from the first arm 118 (e.g., into the disengaged position), is actively initiated manually, such as by engaging the actuator 114.

In one or more examples, linear movement of the second arm 120, for example, toward the first arm 118 (e.g., into the engaged position) and/or away from the first arm 118 (e.g., into the disengaged position), is actively initiated manually, such as by directly engaging the second arm 120.

In one or more examples, linear movement of the second arm 120, for example, toward the first arm 118 (e.g., return to the engaged position) and/or away from the first arm 118 (e.g., return to the disengaged position), is passively initiated, such as by the spring 116 that biases the gripper 112 in either the engaged position (e.g., the second arm 120 rotated toward the first arm 118) or the disengaged position (e.g., the second arm 120 rotated away from the first arm 118).

In one or more examples, the second arm 120 and/or the first arm 118 is coupled to the frame 102 via a suitable translational joint, such as a sliding joint, a linear joint, a prismatic joint, or the like.

Referring to FIGS. 1 and 3-7, in one or more examples, the tool 100 includes the first contact 122 and the second contact 124. The first contact 122 is coupled to the first arm 118. The first contact 122 is configured to engage the wire 150. The second contact 124 is coupled to the second arm 120. The second contact 124 is configured to engage the wire 150. In these examples, the first contact 122 and the second contact 124 contact and hold the wire 150 positioned or passing between the first arm 118 and the second arm 120 when the gripper 112 is moved to the engaged position.

The first arm 118, the second arm 120, the first contact 122, and the/second contact 124 can have any one of various configurations or structural alternatives. In one or more examples, such as those illustrated, the gripper 112 includes a first post 176 that extends outward from the end of the first arm 118. The first contact 122 is coupled to the first post 176. For example, the first contact 122 includes or takes the form of a cylindrical, tubular body that fits over (e.g., around) the first post 176. Similarly, the gripper 112 also includes a second post 178 that extends outward from the end of the second arm 120. The second contact 124 is coupled to the second post 178. For example, the second contact 124 includes or takes the form of a cylindrical, tubular body that fits over (e.g., around) the second post 178.

Referring to FIG. 1, in one or more examples of the tool 100, at least one the first contact 122 and the second contact 124 is made of a contact material 126. The contact material 126 is configured to apply a compression force to the wire 150 when the gripper 112 is in the engaged position. Generally, the compressive force is sufficient to hold the wire 150 and prevent movement of the wire 150 relative to the gripper 112 during an ordinary pull-test performed using the tool 100 to check the wire connection.

In one or more examples of the tool 100, the compression force applied to the wire 150 by the first contact 122 and the second contact 124 is between approximately 2 psi and approximately 6 psi when the gripper 112 is in the engaged position. However, in other examples, the compression force applied to the wire 150 by the first contact 122 and the second contact 124 can be less that approximately 2 psi or greater than approximately 6 psi when the gripper 112 is in the engaged position. The compression force applied to the wire 150 by the first contact 122 and the second contact 124 when the gripper 112 is in the engaged position depends on various factors and is selectable based on the intended application of the tool 100.

In one or more examples of the tool 100, the contact material 126 includes at least one of a foam and/or a rubber. In one or more examples, other suitable materials are also contemplated for use as the contact material 126. In one or more examples, the contact material 126 includes a combination of two or more suitable materials. In one or more examples, the contact material 126 used for the first contact 122 and the contact material 126 used for the second contact 124 are the same. In one or more examples, the contact material 126 used for the first contact 122 and the contact material 126 used for the second contact 124 are different.

Referring to FIGS. 1 and 3-7, in one or more examples, the tool 100 includes the stop 128. The stop 128 is configured to limit movement (e.g., rotational or linear movement) of the second arm 120 relative to the first arm 118 when the gripper 112 is in the engaged position. In some examples, the stop 128 is configured to limit movement (e.g., rotational or linear movement) of the second arm 120 and the first arm 118 relative to each other when the gripper 112 is in the engaged position.

Referring to FIGS. 1 and 3-7, in one or more examples of the tool 100, the stop 128 is coupled to and projects from the first arm 118 or the second arm 120. In the illustrated examples, the stop 128 projects from the first arm 118 (e.g., the stationary or fixed arm of the gripper 112). However, in other examples, the stop 128 can project from the second arm 120 (e.g., the movable arm of the gripper 112).

In various examples of the tool 100, the stop 128 is configured (e.g., sized, shaped, located) to form or maintain the gap 130 between the first arm 118 and the second arm 120 when in the gripper 112 is in the engaged position. The size of the gap 130 formed and/or maintained by the stop 128 is a factor in the compression force created and applied to the wire 150 by the first contact 122 and the second contact 124 when the gripper 112 is in the engaged position.

Referring to FIGS. 1 and 3-7, in one or more examples of the tool 100, the spring 116 is configured to bias the second arm 120 away from the first arm 118. Thus, in these examples, the spring 116 biases the gripper 112 in the disengaged position. However, in other examples of the tool 100, the spring 116 is configured to bias the second arm 120 toward the first arm 118. Thus, in these examples, the spring 116 biases the gripper 112 in the engaged position.

Referring to FIGS. 1, 3 and 4, in one or more examples, the spring 116 is coupled to the first arm 118 and to the second arm 120. In the examples illustrated in FIGS. 3 and 4, while holding the tool 100 by the handle 104, the user pushes (e.g. applies a force with the thumb) against the second arm 120 to move the second arm 120 toward to the first arm 118 to move the gripper 112 to the engaged position and grip the wire 150 between the first contact 122 and the second contact 124, which compresses the spring 116. Upon the user releasing (e.g., removing the force from) the second arm 120, the spring 116 pushes on the second arm 120 away from the first arm 118 to automatically return the gripper 112 to the disengaged position and release the wire 150 from between the first contact 122 and the second contact 124.

Referring to FIGS. 1 and 5-7, in one or more examples of the tool 100, the actuator 114 is configured to move the second arm 120 relative to the first arm 118. In one or more examples of the tool 100, the actuator 114 is configured to move the second arm 120 toward the first arm 118. Thus, in these examples, actuation of the actuator 114 moves the gripper 112 in the engaged position. However, in other examples of the tool 100, the actuator 114 is configured to move the second arm 120 away the first arm 118. Thus, in these examples, the actuator 114 moves the gripper 112 in the disengaged position.

Referring still to FIGS. 1 and 5-7, in one or more examples of the tool 100, the actuator 114 includes the trigger 132 and the spring 116. The trigger 132 is coupled to the second arm 120. The spring 116 is coupled to the trigger 132 and to the frame 102. The trigger 132 is configured to move the gripper 112 between the engaged and the disengaged positions. The spring 116 is configured to bias the gripper 112 in the engaged or disengaged positions.

In one or more examples, as illustrated in FIGS. 5-7, the spring 116 is configured to bias the second arm 120 away from the first arm 118. While holding the tool 100 by the handle 104, the user squeezes (e.g. applies a force with the finger) against the trigger 132 to move the second arm 120 toward to the first arm 118 and grip the wire 150 between the first contact 122 and the second contact 124, which compresses the spring 116. Upon the user releasing (e.g., removing the force from) the trigger 132, the spring 116 acts on the trigger 132 to push the second arm 120 away from the first arm 118, automatically return the gripper 112 to the disengaged position, and release the wire 150 from between the first contact 122 and the second contact 124.

In other examples, the spring 116 is configured to bias the second arm 120 toward the first arm 118. While holding the tool 100 by the handle 104, the user squeezes (e.g. applies a force with the finger) against the trigger 132 to move the second arm 120 away to the first arm 118 for installation of the wire 150 in the tool 100, which compresses the spring 116. Upon the user releasing (e.g., removing the force from) the trigger 132, the spring 116 acts on the trigger 132 to push the second arm 120 toward the first arm 118, automatically returning the gripper 112 to the engaged position and gripping the wire 150 between the first contact 122 and the second contact 124.

Referring now to FIGS. 1, 8 and 9, in one or more examples of the tool 100, the gripper 112 includes the collet 134. The collet 134 is an alternative example of the different structural configurations available for use with the tool 100 as the gripper 112 for selectively engaging and gripping the wire 150 during installation in the wire connector 158 and or pull-testing. The collet 134 can include any suitable configuration, such as a segmented band, sleeve, or jaws that fit around the wire 150 so as the grip the wire 150 when tightened.

In one or more examples of the tool 100, the actuator 114 is configured to close (e.g., tighten) the collet 134. Thus, in these examples, actuation of the actuator 114 moves the gripper 112 in the engaged position. In other examples of the tool 100, the actuator 114 is configured to open (e.g., loosen) the collet 134. Thus, in these examples, the actuator 114 moves the gripper 112 in the disengaged position.

Referring still to FIGS. 1, 8 and 9, in one or more examples of the tool 100, the collet 134 includes a body 136 and jaws 138. The body 136 is coupled to the frame 102. The jaws 138 are disposed within the body 136. The jaws 138 are movable relative to the body 136. In one or more examples, the jaws 138 are inherently biased in an expanded, open, or loosened state. One or both of the jaws 138 and/or the body 136 have a taper (e.g., a gradual reduction of an internal dimension of the body 136 and/or a gradual increase of the outer dimension of the jaws 138), assists in centering and/or clamping force distribution. As such, as the jaws 138 move relative to the body 136, the body 136 acts against the jaws 138 to move the jaws into a collapsed, closed, or tightened state.

Referring to FIGS. 1 and 4-7, in one or more examples of the tool 100, the actuator 114 is configured to move the jaws 138 relative to the body 136 between the engaged position and the disengaged position. In these examples, the actuator 114 moves (e.g., extends and/or retracts) the jaws 138 relative to the body 136 to open (e.g., loosen) and/or close (e.g., tighten) the jaws 138 around the wire 150.

Referring to FIGS. 1 and 4-7, in one or more examples of the tool 100, the actuator 114 includes the slide 140. The slide 140 is coupled to the jaws 138. The spring 116 is coupled to the slide 140 and the frame 102. The slide 140 is configured to move the gripper 112 between the engaged and the disengaged positions. The spring 116 is configured to bias the gripper 112 in the engaged or disengaged positions.

In one or more examples, the spring 116 is configured to bias the jaws 138 in the closed or tightened positioned (e.g., gripper in the engaged position). While holding the tool 100 by the handle 104, the user (e.g. applies a force with the finger) moves the slide 140 rearwardly or forwardly to move the jaws 138 relative to the body 136 and transition the jaws 138 from the closed position to the open position (e.g., moving the gripper 112 to the disengaged position) for installation of the wire 150 in the tool 100, which compresses the spring 116. Upon the user releasing (e.g., removing the force from) the slide 140, the spring 116 acts on the jaws 138 to move the jaws 138 relative to the body 136, automatically returning the gripper 112 to the engaged position and gripping the wire 150 between the jaws 138.

In other examples, the spring 116 is configured to bias the jaws 138 in the open or loosened positioned (e.g., gripper in the disengaged position). While holding the tool 100 by the handle 104, the user (e.g. applies a force with the finger) moves the slide 140 rearwardly or forwardly to move the jaws 138 relative to the body 136, transition the jaws 138 from the open position to the closed position (e.g., moving the gripper 112 to the engaged position), and grip the wire 150 between the jaws 138, which compresses the spring 116. Upon the user releasing (e.g., removing the force from) the slide 140, the spring 116 acts on the jaws 138 to move the jaws 138 relative to the body 136, automatically returning the gripper 112 to the disengaged position and releasing the wire 150 from between the jaws 138.

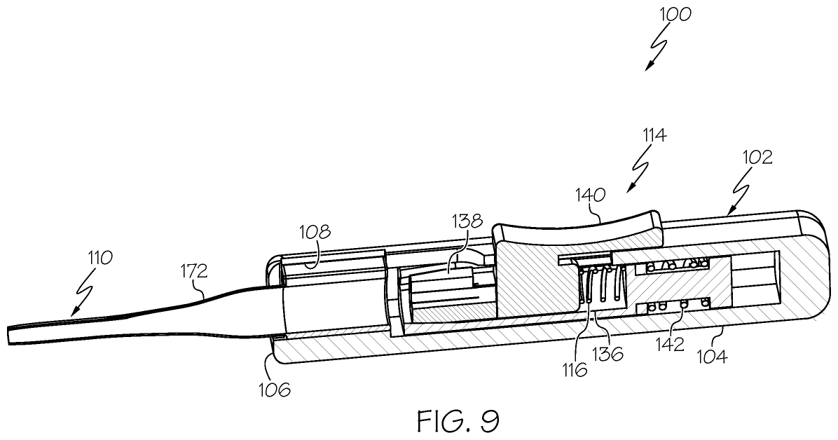

Referring to FIGS. 1 and 9, in one or more examples of the tool 100, the body 136 is movable relative to the frame 102. In one or more examples, the tool 100 includes the second spring 142. The second spring 142 is coupled to the body 136. The second spring 142 resists movement of the body 136 relative to the frame 102. In these examples, the second spring 142 facilitates the pull-test. In one or more examples, with the wire 150 gripped by the jaws 138 and the use applying a pull-force on the tool 100, the body 136 moves (e.g., slides) forward as the tool 100 is pulled. The body 136 sliding forward provides a tactile verification that the wire 150 was able to resist a preset amount of force provided by the second spring 142 and, thus, is properly connected.

In other examples, the tool 100 includes an indicator 182. The indicator 182 is integrated into the frame 102, the gripper 112, and/or the actuator 114 such that a visual indication (e.g., light, color change through an opening, etc.) and/or an audible indication (e.g., click, beep, etc.) is generated when the pull-test is completed and a proper testing pull force has been applied to and resisted by the wire 150.

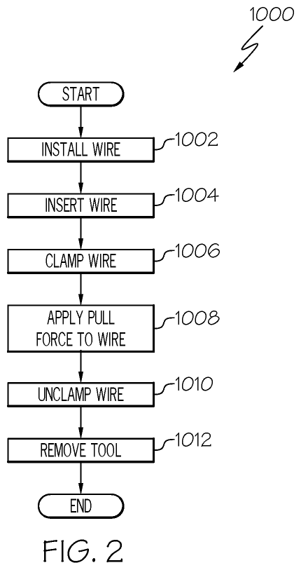

Referring now to FIG. 2, the following are examples of the method 1000, according to the present disclosure. In one or more examples, the method 1000 is implemented using the tool 100 (FIG. 1). The method 1000 includes a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

Referring generally to FIGS. 1 and 3-9 and particularly to FIG. 2, in one or more examples, the method 1000 includes a step of installing 1002 the wire 150 in the tool 100. In one or more examples, the method 1000 includes a step of inserting 1004 the wire end 154 of the wire 150 into the contact opening 156 of the contact block 152 using the tool 100. In one or more examples, the method 1000 includes a step of clamping 1006 the wire 150 with the gripper 112 of the tool 100. In one or more examples, with the gripper 112 clamped to the wire 150, the method 1000 includes a step of applying 1008 the pull force to the wire 150 using the tool 100. In one or more examples, the method 1000 includes a step of unclamping 1010 the wire 150. In one or more examples, the method 1000 includes a step of removing 1012 the wire 150 from the tool 100.

In one or more examples, according to the method 1000, the step of installing 1002 the wire 150 includes a step of situating the wire 150 relative to the insertion tip 110 of the tool 100 and a step of situating the wire 150 relative to the gripper 112 of the tool 100. For example, the wire 150 is installed in the tool 100 by positioning (e.g., passing or running) the wire 150 through, between, or in the gripper 112 and through the insertion tip 110 such that a portion of the wire 150 is in the gripper 112 and the wire end 154 (e.g., the wire pin 162) extends form the insertion end of the insertion tip 110. In one or more examples, the step of installing 1002 the wire 150 includes a step of moving the gripper 112 to the disengaged.

In one or more examples, according to the method 1000, the step of clamping 1006 the wire 150 includes a step of moving the gripper 112 from the disengaged position to the engaged position. In one or more examples, the step of moving the gripper 112 from the disengaged position to the engaged position includes a step of moving the second arm 120 toward the first arm 118 to grip the wire 150 between the first contact 122 and the second contact 124. In one or more examples, the step of moving the gripper 112 from the disengaged position to the engaged position includes a step of moving the jaws 138 relative to the body 136 to grip the wire 150 between the jaws 138.

In one or more examples, the method 1000 includes a step of biasing the gripper 112 in the disengaged position. In one or more examples, the step of biasing the gripper 112 in the disengaged position includes a step of biasing the second arm 120 away the first arm 118. In one or more examples, the step of biasing the gripper 112 in the disengaged position includes a step of moving the jaws 138 relative to the body 136 to open or loosen the jaws 138.

Alternatively, in one or more examples, the method 1000 includes a step of biasing the gripper 112 in the engaged position. In one or more examples, the step of biasing the gripper 112 in the engaged position includes a step of biasing the second arm 120 toward the first arm 118. In one or more examples, the step of biasing the gripper 112 in the engaged position includes a step of moving the jaws 138 relative to the body 136 to close or tighten the jaws 138.

In one or more examples, according to the method 1000, the step of clamping 1006 the wire 150 applies a compression force to the wire 150. In one or more examples, the compression force is between approximately 2 psi and approximately 6 psi.

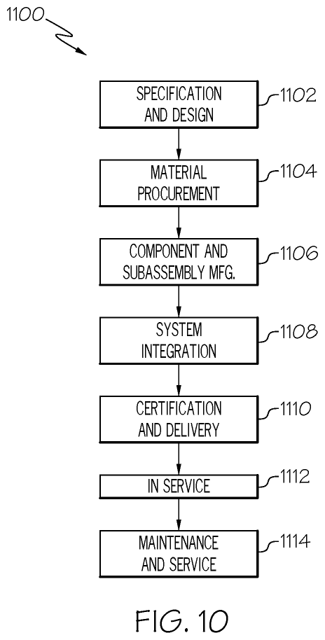

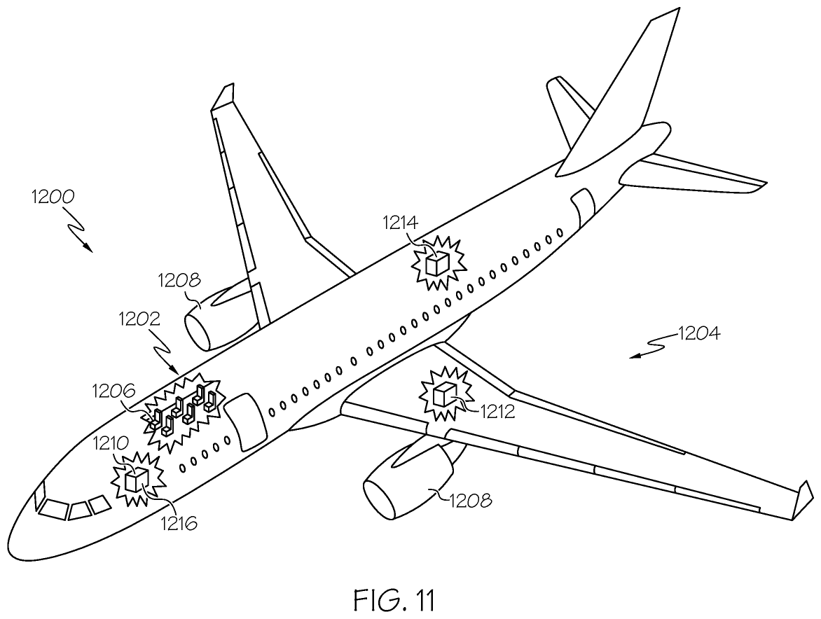

Referring now to FIGS. 10 and 11, examples of the tool 100 and the method 1000 described herein, may be related to, or used in the context of, the aerospace manufacturing and service method 1100, as shown in the flow diagram of FIG. 10 and an aircraft 1200, as schematically illustrated in FIG. 11. As an example, the aircraft 1200 and/or the manufacturing and service method 1100 may include or utilize electrical components that include wires installed in electrical connections using the tool 100 and/or according to the method 1000.

Referring to FIG. 11, which illustrates an example of the aircraft 1200. The aircraft 1200 can be any aerospace vehicle or platform. In one or more examples, the aircraft 1200 includes the airframe 1202 having the interior 1206. The aircraft 1200 includes a plurality of onboard systems 1204 (e.g., high-level systems). Examples of the onboard systems 1204 of the aircraft 1200 include propulsion systems 1208, hydraulic systems 1212, electrical systems 1210, and environmental systems 1214. In other examples, the onboard systems 1204 also includes one or more control systems coupled to the airframe 1202 of the aircraft 1200. In yet other examples, the onboard systems 1204 also include one or more other systems 1216, such as, but not limited to, communications systems, avionics systems, software distribution systems, network communications systems, passenger information/entertainment systems, guidance systems, radar systems, weapons systems, and the like. The aircraft 1200 can have any number of electrical components that include wires installed using tool 100 and/or according to the method 1000.

Referring to FIG. 10, during pre-production of the aircraft 1200, the manufacturing and service method 1100 includes specification and design of the aircraft 1200 (block 1102) and material procurement (block 1104). During production of the aircraft 1200, component and subassembly manufacturing (block 1106) and system integration (block 1108) of the aircraft 1200 take place. Thereafter, the aircraft 1200 goes through certification and delivery (block 1110) to be placed in service (block 1112). Routine maintenance and service (block 1114) includes modification, reconfiguration, refurbishment, etc. of one or more systems of the aircraft 1200.

Each of the processes of the manufacturing and service method 1100 illustrated in FIG. 10 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the tool 100 and the method 1000, shown and described herein, may be employed during any one or more of the stages of the manufacturing and service method 1100 shown in the flow diagram illustrated by FIG. 10. In an example, electrical connections of the aircraft 1200 can be installed using the tool 100 and/or according to the method 1000 during a portion of component and subassembly manufacturing (block 1106) and/or system integration (block 1108). Further, electrical connections of the aircraft 1200 can be installed using the tool 100 and/or according to the method 1000 while the aircraft 1200 is in service (block 1112). Also, electrical connections of the aircraft 1200 can be installed using the tool 100 and/or according to the method 1000 during system integration (block 1108) and certification and delivery (block 1110). Similarly, electrical connections of the aircraft 1200 can be installed using the tool 100 and/or according to the method 1000 while the aircraft 1200 is in service (block 1112) and during maintenance and service (block 1114).

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1, 3-9 and 11, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1, 3-9 and 11, referred to above, need be included in every example and not all elements, features, and/or components described herein are necessarily depicted in each illustrative example. Accordingly, some of the elements, features, and/or components described and illustrated in FIGS. 1, 3-9 and 11 may be combined in various ways without the need to include other features described and illustrated in FIGS. 1, 3-9 and 11, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1, 3-9 and 11, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1, 3-9 and 11, and such elements, features, and/or components may not be discussed in detail herein with reference to each of FIGS. 1, 3-9 and 11. Similarly, all elements, features, and/or components may not be labeled in each of FIGS. 1, 3-9 and 11, but reference numerals associated therewith may be utilized herein for consistency.

In FIGS. 2 and 10, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 10 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the tool 100 and the method 1000 have been shown and described, modifications may occur to those skilled in the art upon reading the specification. The present application includes such modifications and is limited only by the scope of the claims.

1. A tool comprising:
a frame comprising a handle and a working end;
a receiver disposed at the working end and configured to hold an insertion tip, wherein a wire passes through the insertion tip; and
a gripper coupled to the frame and selectively movable between an engaged position and a disengaged position,
wherein:
in the engaged position, the gripper clamps the wire to prevent movement of the frame relative to the wire; and
in the disengaged position, the gripper unclamps the wire to enable movement of the frame relative to the wire.

2. The tool of claim 1, further comprising an actuator configured to move the gripper between the engaged position and the disengaged position.

3. The tool of claim 1, further comprising a spring configured to bias the gripper in the disengaged position.

4. The tool of claim 1, wherein the gripper comprises:
a first arm fixed relative to the frame; and
a second arm movable relative to the frame.

5. (canceled)

6. The tool of claim 4, wherein the second arm is rotationally movable relative to the frame.

7. The tool of claim 4, further comprising:
a first contact coupled to the first arm and configured to engage the wire; and
a second contact coupled to the second arm and configured to engage the wire, wherein at least one the first contact and the second contact are made of a contact material configured to apply a compression force of between approximately 2 psi and approximately 6 psi to the wire when the gripper is in the engaged position.

8. (canceled)

9. The tool of claim 4, further comprising a stop configured to limit movement of the second arm relative to the first arm when the gripper is in the engaged position.

10. (canceled)

11. The tool of claim 4, further comprising a spring configured to bias the second arm away from the first arm.

12. The tool of claim 4, further comprising an actuator configured to move the second arm relative to the first arm.

13. The tool of claim 12, wherein the actuator comprises:
a trigger coupled to the second arm; and
a spring coupled to the trigger and configured to bias the second arm away from the first arm.

14. The tool of claim 1, wherein the gripper comprises a collet.

15. The tool of claim 14, further comprising an actuator configured to open and close the collet.

16. The tool of claim 14, wherein the collet comprises:
a body coupled to the frame; and
jaws disposed within the body and movable relative to the body.

17. The tool of claim 16, further comprising an actuator configured to move the jaws relative to the body between the engaged position and the disengaged position.

18. The tool of claim 17, wherein the actuator comprises:
a slide coupled to the jaws; and
a spring coupled to the slide and configured to bias the jaws in the engaged position.

19. The tool of claim 18, wherein the body is movable relative to the frame.

20. The tool of claim 19, further comprising a second spring coupled to the body that resists movement of the body relative to the frame.

21. A tool comprising:
a frame comprising a handle and a working end;
an insertion tip disposed at the working end, wherein a wire passes through the insertion tip; and
a gripper coupled to the frame and selectively movable between an engaged position and a disengaged position,
wherein:
in the engaged position, the gripper clamps the wire to prevent movement of the frame relative to the wire; and
in the disengaged position, the gripper unclamps the wire to enable movement of the frame relative to the wire.

22. A method for inserting a wire in a contact block, the method comprising:
installing the wire in a tool;
inserting a wire end of the wire into a contact opening of the contact block using the tool;
clamping the wire with a gripper of the tool; and
with the gripper clamped to the wire, applying a pull force to the wire using the tool.

23-26. (canceled)

27. The method of claim 22, wherein clamping the wire applies a compression force of between approximately 2 psi and approximately 6 psi to the wire.
